(19) United States
(12) Patent Application Publication
(10) Pub. No.: US 2010/0280664 A1
(43) Pub. Date: Nov. 4, 2010

(54) MEASUREMENT AND CONTROL BY SOLID AND GAS PHASE RAMAN SPECTROSCOPY OF MANUFACTURING PROCESSES FOR CHEMICALLY CROSSLINKED POLYETHYLENE FOR INSULATED ELECTRIC CABLES AND FOR OTHER PRODUCTS

(75) Inventors: Mark Stephen Kemper, Adrian, MI (US); Robert John Rayzak, Toronto (CA)

Correspondence Address: GROSSMAN, TUCKER, PERREAULT & PFLEGER, PLLC, 55 SOUTH COMMERICAL STREET, MANCHESTER, NH, 03101, US

(73) Assignees: SKUNKWORKS LABORATORIES, Perth, ON (CA); KAISER OPTICAL SYSTEMS, Ann Arbor, MI (US)

(21) Appl. No.: 12/667,744

(22) PCT Filed: Jul. 4, 2008
(86) PCT No.: PCT/CA08/01236

§ 371 Date: Jun. 21, 2010

(30) Foreign Application Priority Data
Jul. 5, 2007 (CA) 2593139

(51) Int. Cl. C08F 2/00; G05B 21/00; G01J 3/44

(52) U.S. Cl. 700/269; 356/301

(57) ABSTRACT

A system and method is described to measure condensed phase and gas phase by-products in the production of chemically cross-linked polyethylene products and, further, for control of the production process.

### FIELD OF THE INVENTION

The system and method described herein relates generally to the production of chemically cross-linked polyethylene products, and more particularly to the measurement of by products of the chemically cross-linked polyethylene products.

### BACKGROUND

Extruded polyethylene has been used as a dielectric in electrical cables for more than forty years. Because of the nature of the polymer, the use of polyethylene (PE) in power cables was usually confined to the lower voltage distribution class cables. However, because of advances in cleanliness of materials, extrusion techniques, cross linking methods and material handling polyethylene has been used in cables of higher and higher voltages and stress levels.

In a cross-linked polyethylene insulated power cable, a high current flows through a central conductor and the insulation surrounding the conductor is subjected to high temperatures and a temperature gradient. The maximum temperature typically occurs adjacent to the central conductor and under normal conditions will be approximately 90 degrees C. on a continual basis and approximately 130 degrees C. under overload conditions. The polyethylene is cross-linked to provide sufficient mechanical strength to withstand the high temperatures.

A chemical process is the most commonly used method to crosslink the polymer. However, chemical cross linking of polyethylene using initiators such as dicumyl peroxide (a common cross-linking agent) creates byproducts such as acetophenone, cumyl alcohol, alpha methyl styrene, methane, ethane and water. The polar compounds among these byproducts (e.g., cumyl alcohol) can affect the electrical stress distribution in the polymer and influence the results of tests performed to check the high voltage capability of the cables prior to installation.

As the volatile polar cross-linking byproducts diffuse out of the polymer its dielectric strength decreases. By the time the insulation is relatively free of such byproducts its dielectric strength is significantly lowered. Because the cable user needs to know the ultimate lowest strength of the cable insulation the general practice is to decrease the concentration of the volatile cross-linking byproducts from the newly manufactured cables before they are commissioned into service. This practice helps the user to obtain more reliable data from the breakdown tests and to detect any flaws in the manufactured product. The concentrations of the volatile cross-linking byproducts are decreased by treating (conditioning) the cable for several days at a high temperature in an oven. The measurement of these polar byproducts conveniently, quickly and frequently in a production environment has not been practicable until the emergence of the exemplary embodiments.

The non-polar compound, methane, can cause voids in the still-soft XLPE if methane is not controlled under pressure during extrusion of the XLPE onto the conductor. Methane may also be a danger due to its flammability and explosiveness at concentrations of between approximately 5% and approximately 15% by volume in air.

Intra-molecular methane trapped in the cable insulation can cause pressure to separate cable joins leading to gaps, partial discharges and, ultimately, cable failure. Even in such a disagreeable state the methane concentration can be very low (30 ppm, approximately 0.003 wt % in XLPE) yet can cause the undesirable pressures. Convenient and reliable measurement of methane has been difficult in previous production environments.

Usually, cables are tested after production to check the integrity of the product and the ultimate user conducts acceptance tests before energizing the cables. Cable manufacturers have used various methods to date to determine the concentrations of byproducts in cable manufacturing. For example, a common byproduct analysis method used by manufacturers is to weigh the sample cable at successive times to measure the loss of the undesirable byproducts. This method gives no direct measure of individual byproducts and, in particular, no direct measure of any individual byproduct of significant concern (e.g., methane) to a manufacturer or user.

Chemiluminescense methods have been used to determine cable characteristics due to aging, however these methods have not been used in the production of XLPE products.

A method of determining the concentrations of byproducts, of a cable, in a laboratory is to cut off pieces of the cable after some stage of the high temperature treatment, extract the byproducts from the polymer for several hours and then analyze them with a mass spectrometer. This method is cumbersome and time consuming and not suited for use in a production environment.

A thermoluminescence method can provide an in situ measurement of the total concentration of cross-linking byproducts in power cable insulation. It thereby is not necessary to cut pieces from the cable and to spend time extracting the byproducts for analysis. The intensity of the emitted light provides a direct indication of the overall concentration of byproducts present in the cable and the heat treatment can be stopped when the desired level has been reached. However, this method has been shown to only measure an aggregate concentration of byproducts not including methane. Further the instrument must be placed outside of a treatment oven and measures through a window in the oven into a section cut into the cable's outer semi-conductor sheath.

Another commonly used measurement method is FT-IR (Fourier Transform-Infra Red). This method is laboratory-based whereby pieces are taken from the body of the XLPE under consideration for analysis. There is no means to interface an FT-IR system to a remote electric cable sample in, for example, a cable manufacturer's conditioning oven. Furthermore FT-IR measures only a small amount of sample which may bring into question the representative nature of such measurements of bulk materials such as the ones under consideration for XLPE products.

Other products such as medical appliances and goods packaging containers fabricated from XLPE can benefit similarly from the in situ monitoring and measurement of the characteristics of the polymer and its byproducts concentrations. In such cases measurements could be taken from samples off a production line. The process parameters can then be adjusted on the basis of measurements so-taken to modify the products' qualities.

Raman spectroscopy has been successfully demonstrated as a method capable of detecting and measuring some organic compounds. One technique involves the use of a laser that is employed to excite the material under examination. The subject compound emits radiation that is shifted in wavelength from the original incident energy. The resulting output is a spectrum that displays the shifted radiation as peaks. The frequency position of the resulting peaks relative to the incident laser is indicative of the functional groups present in the subject material. This provides the basis for qualitative identification of the species in the material. Moreover, the intensities of the peaks are directly related to the concentrations of the individual compounds present in the subject material. This provides the basis for quantitative determination of the species in the material.

The output of such a Raman spectrographic test is a spectrum showing the intensity and frequency bands of components. It should be noted that not all chemical compounds are Raman active. Raman spectroscopy has not been applied to measure the byproducts of XLPE prior to the exemplary embodiments.

The cable manufacturing process involves several stages of mechanical and thermal treatments. For XLPE cables, the insulating material is extruded onto the conductor: the cable enters the extrusion process whereby the initiator is introduced and induces polymer cross-linking. A triple extrusion process used worldwide extrudes simultaneously the inner semi-conductive layer, the insulation and the outer semi-conductive layer onto the conductor.

Electric cable described herein consists of a conductor (e.g., aluminum or copper) covered by several insulation layers. A typical cable has two shield layers of a semi conductor material. The first layer is applied onto the conductor to damp impulse currents over the cable. The second layer shields the insulation and reduces surface voltage to zero. The extruded shields are usually made of the same polymer as the insulation with addition of carbon black particles to provide the requisite semi-conductivity.

For cable manufacturing the insulation material is supplied as solid polyethylene pellets that are converted to the insulation by extrusion. The insulation and semi-conductive shields are extruded onto the conductor simultaneously. To achieve the properties desired for the cable insulation the polyethylene is usually cross-linked with added peroxides as initiators. When the extrusion is complete the cable enters the curing stage with elevated temperatures where the peroxide decomposes and induces the cross-linking. Before being wound on a take-up reel the cable passes through the cooling zone where the insulation solidifies.

Several different types of cable manufacturing lines are used in the industry. They can be vertical, horizontal or catenary configurations. A typical line is divided into several zones: each zone is kept at a constant temperature during the production process.

In previous production environments, temperatures and amounts of cross-linking chemicals, for example, are kept constant at pre-calculated levels according to “recipes” handed down by the manufacturers' technical departments. Expected concentrations of byproducts of the cross-linking procedure are determined by such pre-calculations. Because of the difficulty of measuring byproducts by existing laboratory analytical methods (e.g., mass spectrometry) in a production environment, such a pre-calculation technique is all that was practical. The residual aggregate of byproducts after conditioning is thereby measured in a practical production sense by the diminishment of weight of the cable before and after conditioning. Any sophistication of measurement technique that provides, in a production process, rapid measurement of byproducts content, let alone of specific individual byproduct(s) has not been possible until the emergence of the exemplary embodiments.

Background information may be found in the following documents:
Improved Productivity for Power Cable Manufacture, H. Faremo et al., B1-109, CIGRE 2006.
The Role of Degassing in XLPE Power Cable Manufacture, T. Andrews et al., IEEE Electrical Insulation Magazine, Vol. 22, No. 6, November/December 2006.
U.S. Pat. No. 7,148,963, Large-collection-area optical probe, Dec. 12, 2006, Owen; Harry et al.
U.S. Provisional Patent Application Ser. No. 60/862,109, Fiber-Coupled Raman Probe for Gas Phase Measurements, Oct. 19, 2006, J. Tedesco et al.
U.S. Pat. No. 5,956,138, Multiple-zone emission spectra collection, Sep. 21, 1999, Slater, Joseph B.
U.S. Pat. No. 6,907,149, Compact optical measurement probe, Jun. 14, 2005, Slater, Joseph B.
Cable Systems for High and Extra-High Voltage, E. Peschke and R. von Olshausen, Publicis MCD Verlag, 1999.
Canada Patent #2,118,197, Measurement of Cross-Linking Byproducts in Crosslinked Polyethylene, 2002/04/02, S. Bamji et al.
U.S. Pat. No. 5,533,807, Measurement of Crosslinking By-Products in Crosslinked Polyethylene, Jul. 9, 1996, S. Bamji et al.
Canada Patent # CA 993596, Control of Emulsion Polymerization Process, Jul. 20, 1976, R. Rayzak et al.
Application of Oxidation Induction Time and Compensation Effect to Diagnosis of HV Polymeric Cable Insulation, C. C. Montari et al., IEEE Trans. On Dielectrics and Electrical Insulation, Vol. 3, No. 3, June 1996.
Thermo-Physical Processes During the Production of XLPE Insulated Cables, Dr. Galina Shugal et al., Proceedings of IMECE '03, 2003 ASME International Mechanical Engineering Congress, Washington, D.C., Nov. 15-21, 2003.
Chemiluminescence: A Promising New Testing Method For Plastic Optical Fibers, B. Schartel et al., J. of Light Wave Technology 17(11): 2291-2296, November 1999.
Using DSC, Chemiluminescence and FTIR to Determine the Oxidative Stability of Aged XLPE Cable, A. Campus et al., Proc. 7^{th} International Conference on Properties and Applications of Dielectric Materials, June 2003.
Characterization of Polyethylene Cable Insulation by Chemiluminescence Measurements, I. Method Development, Anthony R. Cooper, Polymer Engineering and Science, August 1987, Vol. 27, No. 15.
Evaluation of Sensitive Diagnostic Techniques for Cable Characterization: Nine Diagnostic Tools, M. S. Mashikian et al., EPRI report EL-7076, December 1990.
Thermoluminescence in XLPE Cable Insulation, S. S. Bamji et al., IEEE Trans. On Dielectrics and Insulation, Vol. 3, No. 2, 1996.
Control of Nonlinear and Hybrid Process Systems: Designs for Uncertainty, Constraints and Time-Delays, Christophides, P. D. and El-Farra, N. H., Springer, 2005
Analytical Applications of Raman Spectroscopy, Pelletier, M. J., Blackwell Publishing, Oxford, 1999.

### SUMMARY OF THE INVENTION

It is the object of the present disclosure to apply Raman spectroscopy with both a large-collection-area optical probe and a gas phase probe together with their individual sampling chambers plus suitably modified measurement instruments and their modified software to the novel application of the measurement of concentrations of all the individual byproducts in XLPE. These measurements are made further useful with a separate computer to make the calculations to provide a basis of improvement of both the understanding of the processes and of the control and/or improvement of design of the processes making XLPE products.

Moreover, the speed at which these measurements can be taken is improved over conventional methods used to date. Thereby, process control can be implemented with the aid of these measurements. Absent the exemplary embodiments described herein the cable manufacturers set process control variables by pre-computation of temperatures, feed rate of cross-linking chemical(s), throughput rate of extruded cable into conditioning ovens, etc., by set formulae and know-how. These settings are typically not changed within any desired batch. This rigidity of settings can be primarily attributed to the restrictions imposed by the industry's simplistic means of measuring byproducts, e.g., by gross weight loss. Other manufacturers of XLPE goods use similar “open-loop” control methodology.

Moreover, the improved instruments described herein when placed in a production process can be used to measure and control a concentration level of one or all or any combination of the byproducts. Otherwise, the industry can diminish the concentration of only an aggregate of byproducts without reference to individual components.

Use of measurement data as described herein provides a basis for process control never before possible. Also, these data are used with mathematical algorithms and sophisticated statistical analysis software to calculate improved set points for the XLPE cable manufacturing process and for the manufacturing processes of other products using XLPE.

Further, the data can be employed with several optimal estimation techniques such as the Kalman method, for example, used for chemical processes, to achieve improved process control. The state of a process described by many variables can be estimated well, even in the presence of significant process noise and instrument error, from the measurement of only a few of the process variables. This was demonstrated for a synthetic rubber manufacturing process. Using the measurement techniques described herein this estimation procedure can be used successfully.

Embodiments in accordance with the present disclosure have the beneficial characteristics that it is portable within a production environment and its sampling probes can be placed inside a conditioning oven to take measurements and transmit them via a fiber optic cable to the Raman laser measurement instrument.

In accordance with the present disclosure there is provided a system for measuring by-products of a chemically cross-linked polyethylene product. The system comprises an instrument for measuring a condensed phase by-product of the chemically cross-linked polyethylene product, and an instrument for measuring a gas phase by-product of the chemically cross-linked polyethylene product.

In accordance with a further embodiment of the present disclosure there is provided a method for measuring by-products of a cross-linked polyethylene product. The method comprises measuring a condensed phase by-product of the chemically cross-linked polyethylene product using a condensed phase instrument and measuring a gas phase by-product of the chemically cross-linked polyethylene product using a gas phase instrument.

Other aspects and features of exemplary embodiments will be readily apparent to those skilled in the art from a review of the following detailed description of exemplary embodiments in conjunction with the accompanying drawings.

### BRIEF DESCRIPTION OF THE DRAWINGS

Exemplary embodiments will be further understood from the following description with reference to the drawings in which:

FIG. 1 a) is a schematic of a large-collection-area optical probe and its sampling chamber used in conjunction with the modified Raman laser instruments in accordance with the present disclosure;

FIG. 1 b) is a schematic of a gas phase probe and its sampling chamber used in conjunction with the modified Raman laser instruments of the present disclosure; and

FIG. 2 is a schematic of a general manufacturing process for chemically cross-linked polyethylene products with a Raman measurement device integrated therein to effect improved process measurement and control in accordance with the present disclosure.

### DETAILED DESCRIPTION

This invention relates to the novel use of Raman spectroscopy measurement instruments that are enabled by hardware and software improvements that represent novel advancements of previous inventions to effect measurements in and control of manufacturing processes for chemically cross-linked polyethylene (XLPE). These improvements relate to the measurement of XLPE byproducts concentrations, measurement of individual and aggregate concentrations of byproducts, production quality control and the throughput and improvement of the design of such manufacturing processes.

Exemplary embodiments described herein are useful both to manufacturers of XLPE insulated electrical cables and to their end users and suppliers (power transmission and distribution companies and electric cable distributors) as well as to manufacturers of other products using XLPE. Some of these are, but are not limited to, medical prosthetic devices and goods packaging.

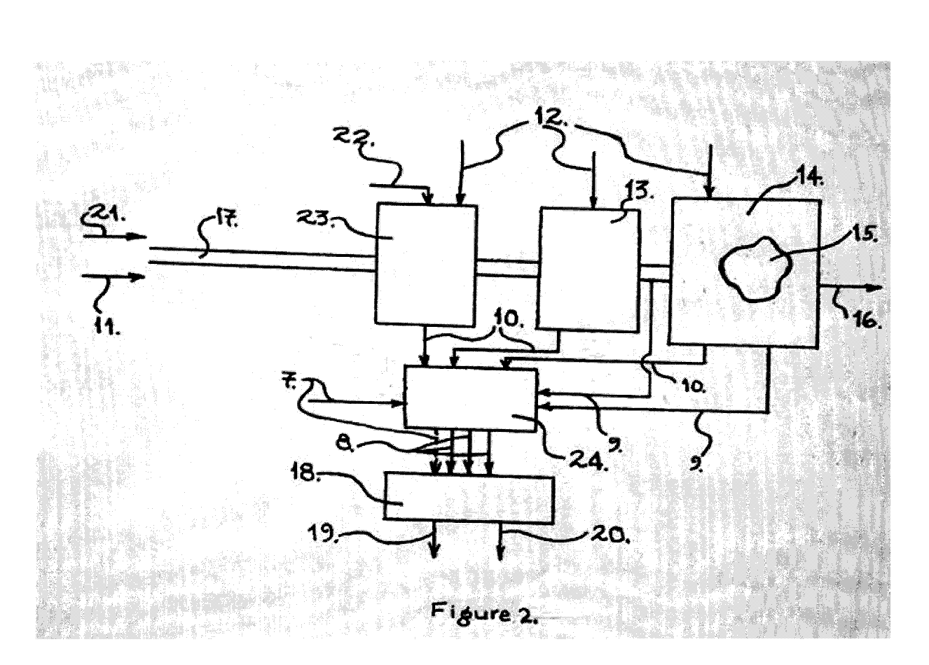

The detailed description, below, of exemplary embodiments discusses application in an XLPE cable manufacturing process. However, the production application could be a different one and still use the same illustrative process blocks illustrated in FIG. 2 but with different functions and names for elements of the FIG. 2 drawing.

### Modifications to and Experimental Testing of the Improved Raman Instruments

A novel method of measuring the concentration of each of the byproducts of goods manufactured with XLPE, for example electric cables, is described herein. This method provides the ability to control and improve the processes involved in manufacturing.

The method uses Raman spectroscopy, a technique utilizing laser technology. Essentially, a laser is focused into a material by a sampling probe. Emitted light is collected by the same probe. The wavelength(s) of the emitted energy are different than that of the incident laser. This is due to the wavelength shift resulting from the Raman effect. The emitted energy can be used to identify the materials in the sample under study. As well, the intensities of the emitted energy at the specific frequencies relates to the relative amount of each component in the sample being measured.

The Raman technique has complexities that can make its application to production environments difficult. That is to say, the Raman method is functional only under certain measurement conditions. It is also dependent on the composition of the subject materials and the construction of the Raman instrument itself. Such was the case leading to the present invention. The probe for condensed phase measurements described in U.S. Pat. No. 7,148,963 is an invention of one of the assignees to the current application as was the probe that is used for measurement of gas phase components, which is described in U.S. Provisional Patent Application Ser. No. 60/862,109. It was the familiarity with these probes that initiated the further modification and development of them in conjunction with the measuring instrument. This led to the capability to measure the entire set of individual XLPE byproducts over the broad range of their concentrations typically found in XLPE. These byproducts are found in fresh production samples and in samples conditioned in ovens (for example, for medium and high voltage cable), ready for delivery and commissioning into service. Products made of XLPE but for applications other than cable can be similarly considered.

A common method of Raman measurement has been to use a very narrow incident laser. This is often accomplished using a microscope. This microscope Raman approach fails to measure the byproducts of XLPE because of its overly restricted narrow sampling beam. It was felt that only a large-collection-area optical probe laser of the type used in the exemplary embodiments would employ representative sampling in such a manner to allow useful, repeatable measurements of the composition of the XLPE. To demonstrate the limitations of microscope Raman for a case such as this, microscope Raman was used to measure the amorphous contents of identical samples of XLPE cable insulation. The amorphous/crystalline ratios were found to vary by over 20%. The microscope Raman technique also could not measure XLPE byproducts concentrations.

The ability to make accurate and repeatable measurements of each of the individual byproducts is a novel application of modified types of previous Raman probes and related instruments. The measurements that were made laid the foundations of the ability to understand further and to control and improve the design of such processes. When a Raman spectrum is obtained experimentally from an attempted analysis of components in a given sample the Raman spectrum must be analyzed to derive useful information from the spectrum.

It should also be noted that no useful spectrum might be obtained from an attempt to analyze a given compound. Such would be the case when trying to analyze compounds that fluoresce excessively. The fluorescence interferes with the reflection of the Raman phase shifted signal and inhibits measurements from being made.

Moreover, a Raman spectrum, if one is obtained, does not intrinsically provide individual wt % concentrations of any component. In order to see if practical concentration information could be obtained from our experimental results, it was necessary to calibrate the spectral information against gas chromatography-mass spectrometry (GC/MS) data for the sample. By doing so, a mathematical model could be created in conjunction with the instrument software. These mathematical constructions include, but are not necessarily restricted to, integration of peaks exhibiting frequencies known to be representative of the components of interest. Computation of the wt % of each component is achieved by calibrating against the GC/MS data for the same specimen(s) (i.e., a calibration sample or samples). Such an approach succeeded in the exemplary embodiments and the instrument is deemed to be able to provide reliable concentration data.

In this way it was possible to improve the Raman condensed phase and gas phase measurement instruments' capabilities to provide for all of the individual byproduct concentrations of XLPE polymer.

It has not previously been possible to assess the success of getting XLPE concentration measurements without such innovative analysis and experimentation as has been necessary to arrive at the realization of the exemplary embodiments. The results shown in Table I and Table II demonstrate that Raman equipment with appropriate probes (for example those described in U.S. Pat. No. 7,148,963, and U.S. Provisional Patent Application Ser. No. 60/862,109), sampling chambers and suitably modified instruments can accomplish the accurate measurement of weight percentages of individual byproduct components of XLPE. Most importantly, the exemplary embodiments can be available as a portable instrument that can provide the full range of byproduct measurements within a few minutes on a continuing basis.

The measurements in Tables I and II are taken from commercially available high voltage (HV) cable. Fresh samples are those not degassed as is typical for low voltage cable applications. Degassed samples are those that would be conditioned in an oven by a manufacturer of medium and high voltage cable.

The measurements shown in Table I were made by GC/MS to show the breadth of methane content that can be found in commercial HV cable insulation. Our experience in the measurement of methane with a gas probe of the exemplary embodiments suggests that the lower limit of quantification is 0.002 wt %. This should allow a measurement to at least 0.003 wt % to be accomplished for a HV cable sample with the devised sampling scheme and to satisfy the ability to measure the published tolerable methane concentration limit for degassing of cables.

We can thereby expect to measure readily the wt % concentrations shown in the last line, 0.018 to 0.024 wt %, as well as the 0.003 wt % tolerable methane concentration limit, noted above, by the gas phase probe and its sampling chamber of the exemplary embodiments.

The measurements of the total normal byproducts (cumyl alcohol, acetophenone and alpha methyl styrene) shown in Table II were obtained repeatable within a 1.63% standard deviation by the condensed phase probe and its sampling chamber

TABLE I
Measurement of Methane (CH4), Wt %

| | |
|---|---|
| Fresh Sample | 0.0004 |
| Degassed Sample | 0.0011 |
| Cut in two, Degassed Sample | 0.0014 |
| Cut in two, Fresh Sample | 0.018 to 0.024 |

It is readily seen that there was very little (0.0004 to 0.0011 wt %) CH4 resident in the XLPE near the exposed surfaces, even in the “fresh” samples. Other workers have shown that there would be approximately 0.02 to 0.08 wt % CH4 in freshly produced XLPE cable insulation. We found, too, that the sample assumed to be degassed showed more CH4 (0.0011 wt %) than the fresh sample (0.0004 wt %), an unexpected result given the extreme volatility of methane. The interiors of the samples, either fresh or degassed, showed widely varying wt % concentrations of CH4. The practical meaning of a stated specific concentration of CH4 in XLPE cable insulation must, thereby, be carefully considered.

TABLE II
Measurement of Total Normal Byproducts, Wt %

| | |
|---|---|
| Fresh sample | 2.61 |
| Fresh sample after 24 hrs in vacuum oven | 1.95 |
| 36 hrs | 1.33 |
| 168 hrs (7 days) | 0.58 |
| 336 hrs (14 days) | 0.35 |
| 384 hrs (16 days) | 0.23 |
| Degassed sample from commercial sources | 1.63 |

Note:
During these tests we placed a separate sample as a control in a refrigerator at −2 Celsius. Its normal byproducts concentrations ranged from 2.65 to 2.68 wt % over these 16 days.

In Table II commercially available degassed HV cable samples show significantly less normal byproducts content (1.63 wt %) than the fresh samples (2.61 wt %).

Moreover, we were able to purge considerably more of the normal byproducts from those in degassed manufacturer's samples by means of our vacuum oven. The sample degassed to the manufacturer's standards contained 1.63 wt % total normal byproducts. This is a 37.5% reduction compared to the concentration of the byproducts in the fresh sample but this can be driven much lower (e.g., to 0.23 wt %) by application of heat over time in a vacuum oven. This shows the method of the exemplary embodiments is capable to measure normal byproduct concentrations well below those considered acceptable for commercial electric cable applications.

There is a difference to be noted in measuring the three byproducts cumyl alcohol, acetophenone and alpha methyl styrene (the “normal byproducts”) and the byproduct methane gas. With the large-collection-area Raman optical probe in use in the exemplary embodiments we found that measurements to well below the accepted levels of the normal byproducts imposed by manufacturers can be made.

For methane gas a very low level of concentration is sometimes desired to be measured. In this event, methane cannot be conventionally measured by the large-collection-area Raman optical probe. Rather a gas phase probe used with the modified instrument as used with the condensed phase large-collection-area optical probe is required. The combination of the two probes provides a novel method to measure each of the individual byproducts of XLPE manufacture as a portable unit in a production setting.

Of course, the ability to monitor XLPE characteristics on-the-fly in manufacturing processes other than XLPE cables is also important. Such would be the case for batch or continuous production of any product using XLPE, i.e., medical prosthetic and goods packaging devices.

For some XLPE goods manufacturing processes the measurements could be made on-the-fly and allow continuous control. In other cases, such as in cable manufacturing, the measurements are often made significantly later than when production was completed, i.e., in a conditioning (degassing) oven. The two types of control thereby possible are discussed further herein.

The time taken for measurement of the individual byproduct concentrations is small compared to the time required for changes in the process variables (cross-linking and formation of associated byproducts) affected by the controls (temperature, pressure and peroxide feed rate, etc.). Moreover, measurements of all the normal byproducts can be completed in 2 minutes with the exemplary embodiments. During this time only a few meters of cable will typically have passed through the extruder and vulcanizing stages which are of a length 50 meters or more for HV cable production. Thus, control can be practical in real time and a production run can be modified without loss of any significant length of cable in a typical production run.

There are many measurement techniques commonly used to measure characteristics of chemically induced cross-linking in polyethylene. Some methods are found to be impractical because of the byproduct extracts that are required (as in mass spectrometry) or because of low sensitivities. Mass spectrometry was found to be (and is) a suitable analytical technique but requires several hours to perform from the time samples are gathered to the time byproduct measurements are obtained. This long time is not practical for continuous process control as can be provided for by the exemplary embodiments.

The basis of the exemplary embodiments is the novel application of two Raman spectroscopic probes used with individual sampling chambers and with instruments with hardware and software modifications. This design of the exemplary embodiments is used for XLPE byproducts concentrations measurements in electric cable and other manufacturing processes using XLPE.

The exemplary embodiments have been found by experimental verification to be adaptable in a novel manner to measure each of the byproducts of XLPE. Laboratory results illustrative of the measurements to be taken by these adaptations are shown in Tables I and II. In each case sampling chambers were constructed for both the condensed phase and gas phase probes, respectively, to measure relevant byproducts. The spectrum data so obtained are further analyzed and mathematically manipulated to provide wt % for each byproduct component.

Each instrument adapted to novel application is used in a different manner. For measurement of the byproducts cumyl alcohol, acetophenone and alpha methyl styrene (the “normal byproducts”) a large-collection-area optical probe Raman laser instrument is adapted to novel application in the exemplary embodiments.

For the gas phase byproduct methane (and to a lesser extent ethane) a gas phase Raman instrument is adapted to novel application in the exemplary embodiments.

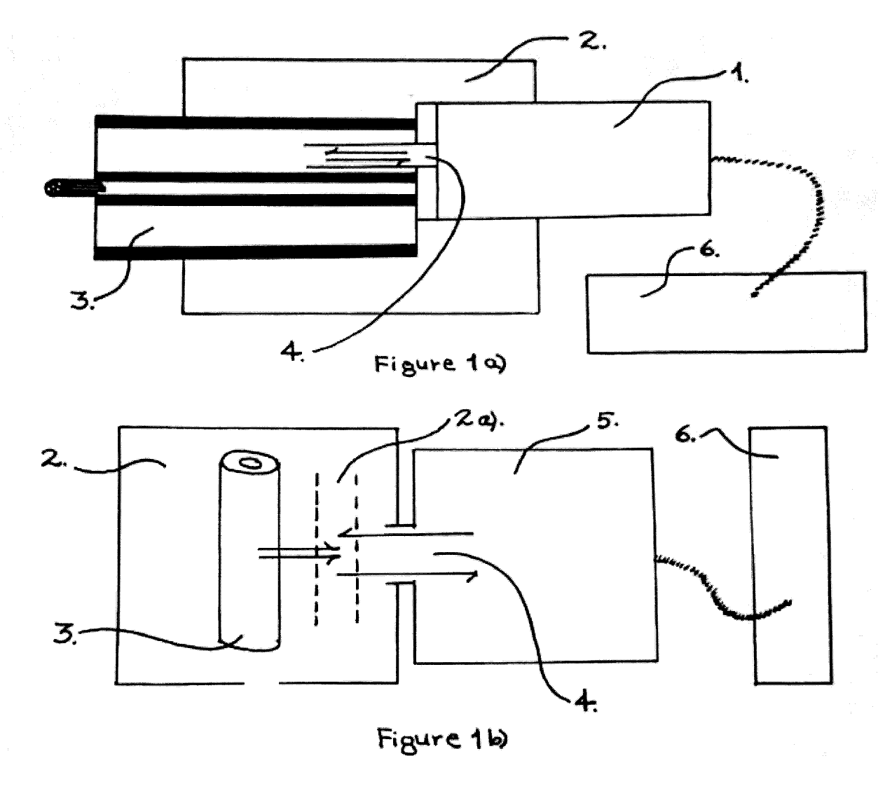

In FIGS. 1 a) and b), respectively, the significant parts of the condensed phase and gas phase probes and their sampling chambers are shown. In FIG. 1 a) the cable sample 3, e.g., the end of a cable as it emerges from the extruder, is secured inside the sampling chamber 2 with the large-collection-area optical probe 1 connected via a fiber optic cable to the measurement instrument 6. The Raman laser excitation and emitted radiation 4 (sourced from and returned to instrument 6) are used in conjunction with the computer of the modified measurement instrument 6 to compute the wt % concentrations of the normal byproducts.

In FIG. 1 b) the cable sample 3 is placed inside a gas phase sampling chamber 2. From the Raman gas phase probe 5 the laser excitation and Raman emitted radiation 4 are directed to and from the sampling chamber 2 and are used in conjunction with the computer of the modified measurement instrument 6 to compute the wt % concentrations of the gas phase byproducts of the XLPE.

The function of the gas sampling chamber 2 in FIG. 1 b) is to be an oven (but not necessarily limited to this function) to heat the XLPE cable sample 3 to drive out the methane gas. This gas is purged into a separate chamber 2 a) by means of an inert gas such as nitrogen. The concentration of methane is measured in 2 a) by laser excitation and emitted radiation 4. Other gas sampling chambers can be devised. For example, a flask may be used as the chamber to hold the sample. The gas phase Raman probe is secured into the flask using an O-ring or other type of gasket to ensure a tight seal of the chamber. The chamber may then be placed in an oven to heat the sample to drive out the methane gas.

The sampling chambers allow the laser probes to connect to the XLPE cable or separate cable samples during production to obtain measurements necessary to assess the production quality and to make process adjustments based on the measurements or to determine if the conditioning of the cable is complete.

In the production of XLPE for cable industries the exact proportions of byproducts realized in the manufacturing process depend on the time and temperature of the insulation as it is extruded on to the conductor and the peroxide cross-linking agent is simultaneously introduced and decomposes. The correct time and temperature profile through the system is extremely important to maintain.

When the cross-linking is completed the insulation should have an approximate constant level of byproducts throughout its thickness given a uniform distribution of peroxide at extrusion. This distribution will change with time after cross-linking as these byproducts diffuse out of the cable depleting the exposed layers first. In FIG. 2 such a process starts in the hot section of the continuous curing or vulcanizing tube 13 but most of the loss occurs outside the tube. Most of the byproducts concentrations are driven out in an oven 14.

Reference to FIG. 2 shows a schematic of the production process using the exemplary embodiments for manufacturing chemically cross-linked polyethylene insulated electric cable or other products. The component parts of the process with the improved measurement instruments with the solid and gas phase probes of FIGS. 1 a) and 1 b) are connected to the instrument and its computer of instrument 24 (the item 6 of FIGS. I a) and 1 b)) and to control device 18. Process measurement streams 10 and laser excitation and emitted radiation to measure byproducts concentrations 9 are fed into the measurement instrument 24 for calculation of byproducts concentrations and for forwarding as inputs 8 to control computer 18. Shown are electric power 7 for the instrument 24 and control computer 18, control temperatures and pressures, 12, curing oven or tube, 13, conditioning or vacuum oven, 14, XLPE cable or other product, 15, supply of products shipped to end-users, 16, extrusion of PE, 21, onto conductor, 11, in process, 17. Alternatively, 21, 11, and 17 can be the feed of PE to, say, casting molds 21 in a fabrication process 17 or other manufacturing process for XLPE constituted products. The cross-linking chemicals, 22, are added in the preparation stage, 23, with the temperature set for this stage plus the curing and heat treatment stages to manufacture XLPE cable or other products with desired polymeric characteristics. That is, the process shown in FIG. 2 can be used to describe other processes wherein a flow of polymer is manufactured into a product with the attendant creation of byproducts.

Usually, temperatures, pressures and cross-linking chemicals and the time for the curing of product are pre-set for a given production run to achieve expected XLPE product characteristics. This method of setting production process variables is often accomplished with the aid of the manufacturer's proprietary algorithms. In contemporary production facilities the process variables are not modified according to on line measurements taken of the product.

However, without the exemplary embodiments there can be no automatic feed of process variable information to a control device that assesses this information (e.g., temperature(s) and concentration(s) of byproduct(s)) and makes adjustments to process control variables 19 and 20 to revise temperatures and pressures 12 and cross-linking chemicals 22 which may be, among others, contemplated by the exemplary embodiments.

The measurement and control methods of the exemplary embodiments are a novel application and improvement to present XLPE production processes. Until the invention of the exemplary embodiments, there was no way to measure cable characteristics rapidly and accurately within the manufacturing process for XLPE electric cable (or for other XLPE manufacturing processes). Indeed, prior instruments use heat treatment testing of XLPE to minimize the aggregate concentration of cross-linking byproducts in a curing oven where the cable insulation is sheathed by a semiconductor layer. In that method an opening is cut in the sheathing in order to make the measurement. This does not contemplate the use of the aggregate concentration measurement for process control.

Nonetheless, for cable manufacturing the methods available for process control via the exemplary embodiments can be based on (but not be limited to) the time delays between measurement and control action that caused the measurement. Two cases of time delays are illustrative:
at the end of the extrusion line—a couple of minutes. In this case the process controls can be adjusted almost immediately.
in the conditioning oven—several days. In this case the recipe can be adjusted for future use to improve the next production batch. Further, the time of residency in the curing oven can be minimized to that needed just to meet the objectives of concentrations of by-products remaining after conditioning in the vacuum oven. In this way production throughput will be maximized. This capability of the exemplary embodiments provides a means to improve power cable productivity that is complementary to recent methods.

For other XLPE production processes more freedom of control is possible. For example, in continuous production of medical prosthetic devices made of XLPE it is possible to change continuously, say, the cross-linking agent concentration to result in the best product according to a pre-set standard of resulting materials quality. These are straightforward since each production item can be individually measured to provide a basis to adjust the process for all subsequent product items.

While particular aspects of the exemplary embodiments have been shown and described, changes and modifications may be made to such embodiments without departing from the true scope of the invention. For example, more than one instrument and computer can be used to have measurements made and assessed in a stage-wise manner along the production process. Also, measurement of other chemically cross-linked polymers in an in situ, continuous and on-the-fly basis in other production processes does not depart from the true scope of the present invention.

Likewise, the embodiments of the present invention can be used in a process to manufacture other products made of chemically cross-linked polyethylene. An example of such a product but not limited to it is a medical prosthetic appliance.

The information gathered in processes that are monitored and controlled by the exemplary embodiments can be used to design improvements into these processes.

1-32. (canceled)

33. A system for measuring by-products of a chemically cross-linked polyethylene product comprising:
an instrument for measuring a condensed phase by-product of said chemically cross-linked polyethylene product using Raman spectroscopy; and
an instrument for measuring a gas phase by-product of said chemically cross-linked polyethylene product using Raman spectroscopy.

34. The system as claimed in claim 33, wherein said measurements of said condensed phase by-product and said gas phase by-product are used to control a process of producing said chemically cross-linked polyethylene product, wherein the process control adjusts at least one process variable including feed stock mass or rate of feed of chemical cross-linking initiators.

35. The system as claimed in claim 33, wherein said measurements of said condensed phase by-product and said gas phase by-product are taken in situ during production of said chemically cross-linked product or are taken in a conditioning oven.

36. The system as claimed in claim 33, wherein said condensed phase instrument comprises:
a condensed sampling chamber for connecting to said cross-linked polyethylene product; and
a laser probe comprising a large collection area optical probe Raman laser instrument for measuring said condensed phase by-product.

37. The system as claimed in claim 33, wherein said gas phase instrument comprises:
a gas sampling chamber for connecting to said cross-linked polyethylene product; and
a Raman gas phase probe for measuring said gas phase by-product.

38. The system as claimed in claim 37, wherein said gas sampling chamber comprises:
a containment chamber for connecting to and heating said cross-linked polyethylene;
a gas phase chamber connected to said containment chamber and said Raman gas phase probe for receiving a volume of gas from said containment chamber,
wherein said volume of gas is purged from said containment chamber into said gas phase chamber using an inert gas.

39. The system as claimed in claim 37, wherein said gas sampling chamber comprises a single containment chamber with said Raman gas phase probe secured to said single containment chamber.

40. The system as claimed in claim 33, further comprising a control system for analysing a Raman spectrum of said condensed phase by-product to determine a weight percentage of said condensed phase by-product in said cross-linked polyethylene and identifying a plurality of condensed phase by-products from said cross-linked polyethylene product using said condensed phase Raman spectroscopy instrument.

41. The system as claimed in claim 33, wherein said condensed phase by-product comprises one of:
acetophenone;
cumyl alcohol; or
alpha methyl styrene,
wherein said gas phase by-product comprises one of:
methane; or
ethane, and
wherein said cross-linked polyethylene product comprises one of:
extruded power cables;
medical devices; or
product packaging.

42. The system as claimed in claim 34, wherein said measurement of at least one of said condensed phase by product or said gas phase by-product is used to determine an end point has been reached in the production of said chemically cross-linked product.

43. A method for measuring by-products of a chemically cross-linked polyethylene product comprising:
measuring a condensed phase by-product of said chemically cross-linked product using a condensed phase Raman spectroscopy instrument; and
measuring a gas phase by-product of said chemically cross-linked product using a gas phase Raman spectroscopy instrument.

44. The method as claimed in claim 43, further comprising:
controlling a process of producing said chemically cross-linked product using said measurements of said condensed phase by-product and said gas phase by-product, wherein controlling the production of said chemically cross-linked product includes adjusting one or more process variables including feedstock mass and rate of feed of chemical cross-linking initiators.

45. The method as claimed in claim 43, wherein said measurement of said condensed phase and gas phase by-products are taken in situ during production of said chemically cross-linked product or are taken in a conditioning oven.

46. The method as claimed in claim 43, wherein measuring said condensed phase by product comprises:
connecting said chemically cross-linked polyethylene product to a condensed phase sampling chamber; and
measuring said condensed phase by-product using a laser probe comprising a Raman laser instrument.

47. The method as claimed in claim 43, wherein measuring said gas phase by-product comprises:
connecting said cross-linked polyethylene product to a gas phase sampling chamber;
measuring said gas phase by-product using a Raman gas phase probe.

48. The method as claimed in claim 47, further comprising:
heating said cross-linked polyethylene product in a containment chamber of said gas phase sampling chamber; and
purging using an inert gas a volume of gas from said containment chamber into a gas phase chamber of said gas phase sampling chamber.

49. The method as claimed in claim 47, further comprising:
heating in an oven said cross-linked polyethylene product in a single chamber with said gas phase Raman probe secured to said single chamber.

50. The method as claimed in claim 43, further comprising:
analysing a Raman spectrum of said condensed phase by-product to determine a weight percentage of said condensed phase by-product in said chemically cross-linked polyethylene; and
identifying a plurality of condensed phase by-products in said cross-linked polyethylene product.

51. The method as claimed in claim 43, wherein said condensed phase by-product comprises one of:
acetophenone;
cumyl alcohol; or
alpha methyl styrene,
wherein said gas phase by-product comprises one of:
methane; or
ethane, and
wherein said cross-linked polyethylene product comprises one of:
extruded electrical power cables;
medical devices; or
product packaging.

52. The method as claimed in claim 43, further comprising determining an end point has been reached in the production of said chemically cross-linked product based on the measurement of at least one of the condensed phase by-product or the gas phase by-product.
